(19) United States
(12) Patent Application Publication
(10) Pub. No.: US 2010/0116446 A1
(43) Pub. Date: May 13, 2010

(54) WINDSCREEN ASSEMBLY FOR ATTACHMENT TO FENCE

(76) Inventor: Frederick Willett, Fort Lauderdale, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/270,086

(22) Filed: Nov. 13, 2008

(51) Int. Cl. E06B 9/24

(52) U.S. Cl. 160/368.1

(57) ABSTRACT

A windscreen system includes mounting panels for affixation to a fence, and a main windscreen sheet removably attachable to the mounting panels. Each mounting panel comprises an elongate panel of material having grommets disposed in spaced relation along the length thereof and hook-and-loop fastening material disposed generally adjacent to said grommets along at least a portion of the length of the panel. Upper and lower mounting panels are affixed to a fence in horizontally disposed, vertically spaced relation, in proximity to the top and bottom portions of the fence, and the main windscreen sheet is removably attached thereto by hook-and-loop fastening.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to wind screens and privacy screens for use with a fence system enclosing an area.

2. Description of Related Art

Fences are well known barrier structures for surrounding and/or defining the boundaries of properties, fields, construction areas, storage sites, sports fields, tennis courts, and other recreational areas. For example, baseball and softball fields commonly include an outfield fence, and tennis courts are routinely surrounded by fence. While a wide variety of fence structures are used in outdoor environments, chain link fence is one of the most common fencing structures in use. A typical chain link fence installation includes a number of spaced posts embedded in the ground to which the chain link barrier is affixed.

Since chain link fences largely consist of open area, it is well known in the art to attach a windscreen (also referred to as “privacy screens”) on the fence. Windscreens function to block the wind, enhance privacy, add security, and provide a uniform visual background for sports participants. Windscreens known in the art typically comprise durable, weather-resistant synthetic mesh material, fabricated in sheets from a variety of materials and mesh configurations. In order to provide a significant amount of wind protection and privacy, most windscreens comprise a synthetic mesh structure having very little open area such that the structure is 80%-100% closed with little or no ftee area. Windscreens typically have reinforced peripheral edges incorporating grommets to allow the windscreen to be securely attached to a fence using suitable attachment devices, such as a tie wraps or rope. As a result, the installation and removal of windscreens is a time consuming and laborious task.

The installation of windscreens on fence systems gives rise to a number of problems. First, depending on the length and height of the fence, the windscreen material alone can be bulky and heavy, and thus require a crew of workers to install and remove. Once installed, the fence system has significantly reduced free area that greatly increases wind loading on the fence structure. Fence systems are typically not designed to handle these forces. As a result, the increased wind loading often times results in the destruction of the fence, particularly in areas prone to high winds, rapidly developing storms, and hurricanes.

In view of the disadvantages present with the use of fence windscreens, the background art reveals a number of attempts to reduce wind loading associated with the use of windscreen systems. One such attempt includes adapting the windscreen with wind vent holes or cutouts with flaps that allow the wind to pass through. Providing wind vent holes and cutouts, however, largely defeats the purpose of the windscreen, namely to provide a wind barrier and privacy. In addition, vent holes detract from the appearance of the windscreen, particularly when combined with laps. In another attempt, published U.S. patent application US 2007/0125994, in the name of Henning, discloses an apparatus and method for shielding an area from wind by using a ballasted windscreen that yields to the wind to reduce stress on the fence. Henning discloses a windscreen that is attached to the fence at its top edge and includes a free-hanging ballasted bottom edge. The ballast functions to maintain the windscreen generally in place under calm conditions while allowing the windscreen to yield downwind in response to high wind. The system disclosed by Henning, however, includes a significant inherent disadvantage, namely that the yielding/flapping windscreen can interfere with the field of play, and possible cause injury, when installed at a sports complex.

As a result of the foregoing limitations and disadvantages present in the art there exists a need for an improved windscreen system.

### BRIEF SUMMARY OF THE INVENTION

The present invention overcomes the limitations and disadvantages present in the art by providing an improved windscreen/privacy screen system (hereinafter “windscreen”). A windscreen system in accordance with the present invention includes mounting panels for affixation to a fence, and a main windscreen sheet removably attachable to the mounting panels. The mounting panels and main windscreen sheet each preferably include hook-and-loop fastening material. In a preferred embodiment, each mounting panel comprises an elongate panel of material having grommets disposed in spaced relation along the length thereof and hook-and-loop fastening material disposed generally adjacent to said grommets along at least a portion of the length of the panel. Upper and lower mounting panels are affixed to a fence in horizontally disposed, vertically spaced relation, in proximity to the top and bottom portions of the fence, and the main windscreen sheet is removably attached thereto by hook-and-loop fastening. In a first embodiment, the use of hook-and-loop fastening material is maximized such that strips thereof run substantially the entire length of the mounting panels and the main windscreen whereby removal of the main windscreen sheet is intended to be accomplished manually. In an alternate embodiment, the amount of hook-and-loop fastening material is minimized such that the force required to separate the main windscreen from the mounting panels is less than the force that would cause structural fence failure, such that the windscreen would automatically breakaway from the fence in high wind conditions.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of a windscreen system in accordance with the present invention;

FIG. 2 illustrates the main wind screen panel in a rolled configuration for storage; and

FIGS. 3-6 are elevational views illustrating installation of the windscreen system on a chain link fence.

### DETAILED DESCRIPTION OF THE INVENTION

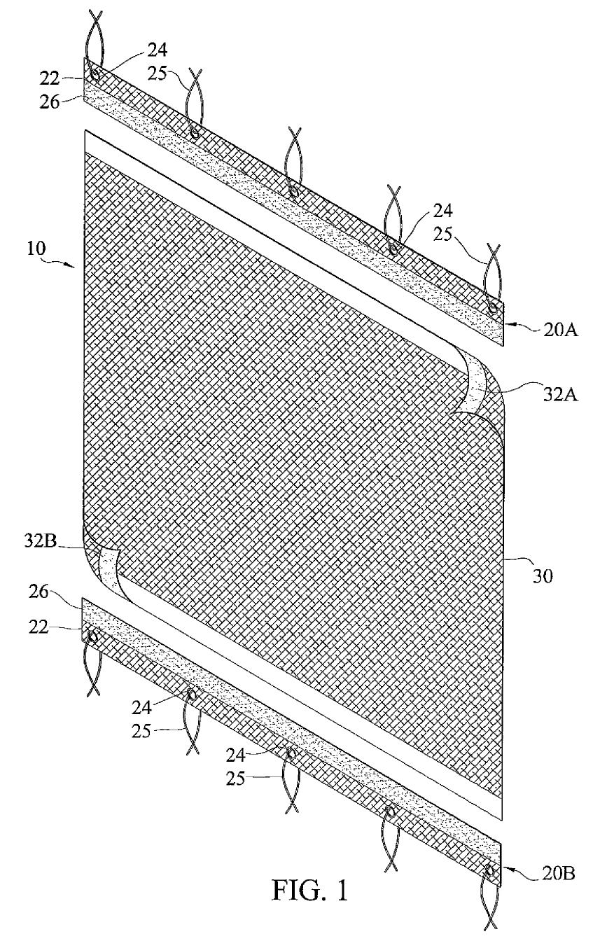

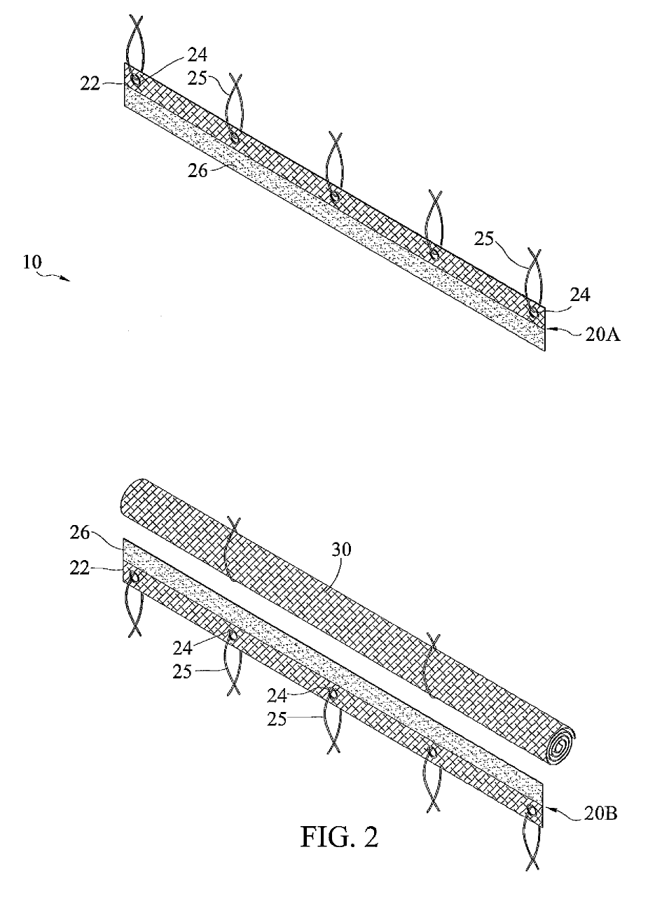

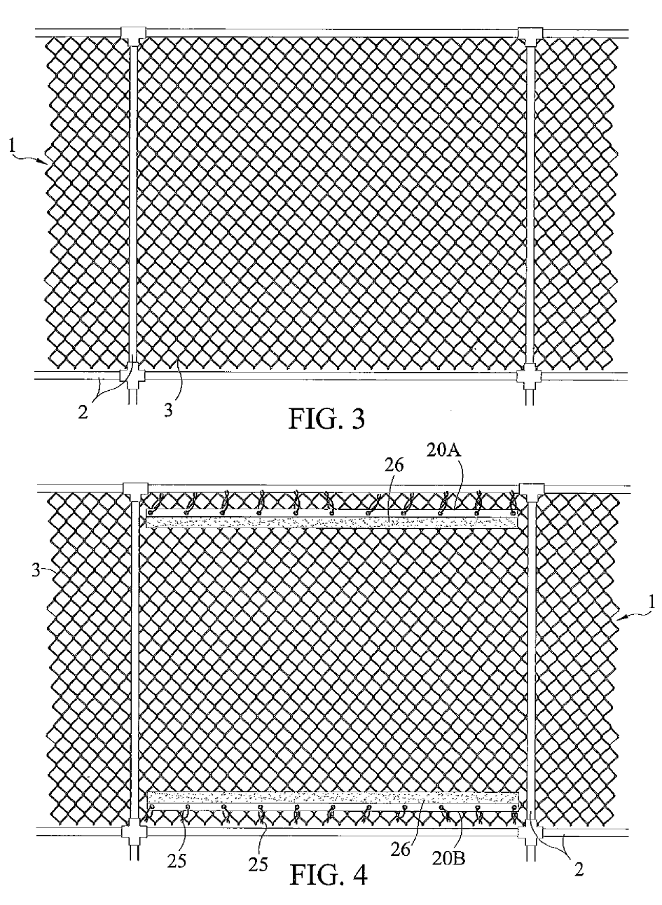

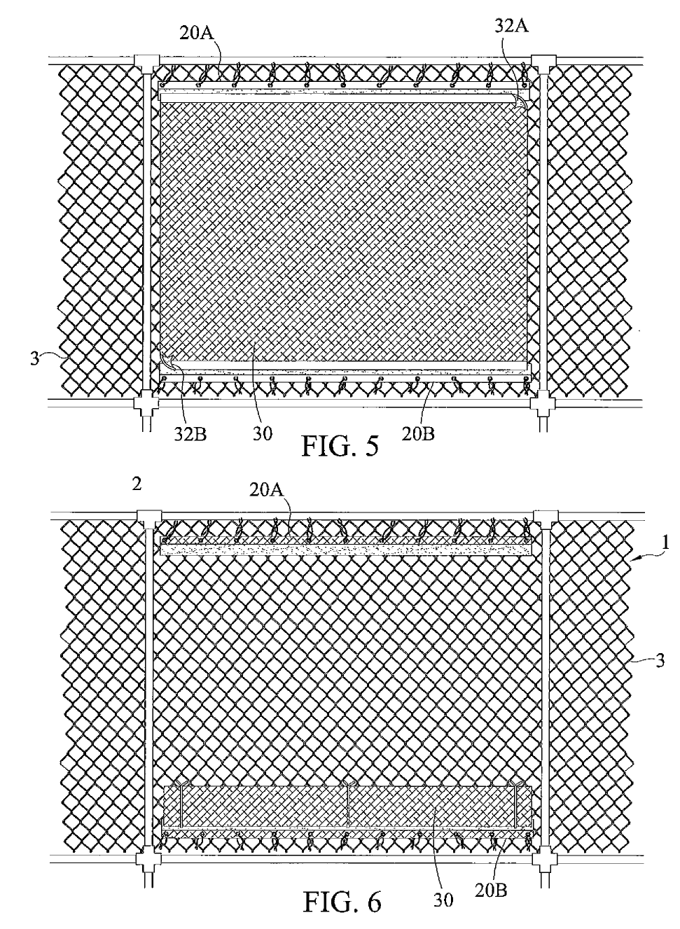

With reference now to the drawings, FIGS. 1-2 depict a windscreen system, generally referenced as 10, in accordance with the present invention. Wind screen system 10 is specifically configured for installation on a fence, referenced as 1, as illustrated in FIGS. 4-6. As best seen in FIG. 3, fence 1 includes a plurality of vertically disposed fence posts 2 mounted in the ground, and fence material 3 (such as chain link) connected to the fence posts spanning the distance between the posts.

In a preferred embodiment, windscreen system 10 includes upper an lower mounting panels, generally referenced as 20A and 20B respectively, and a main windscreen sheet 30. In a preferred embodiment, mounting panels 20A and 20B are essentially structurally identical. Panels 20 and windscreen sheet 30 are preferably fabricated from synthetic fabric formed in a flexible mesh sheets. Suitable material includes polypropylene, polyethylene, PVC-coated polyester, or any other weather resistant material.

Each mounting panel 20A and 20B preferably comprises an elongate panel body 22 of weather resistant material. Each mounting panel 20 extends along a longitudinal axis and includes a first reinforced peripheral edge having grommets 24 disposed in spaced relation along the length thereof on a first side of said axis. Grommets 24 are preferably metal, plastic, or rubber, rings inserted into a hole made through the material and function to reinforce the hole. Grommets 24 may be suitably spaced, e.g. 12.0″ or 18.0″ on center, or any other suitable spacing dimension. In a preferred embodiment, each mounting panel 20 further includes an elongate strip of hook-and-loop fastening material 26 secured thereto on the second side of the longitudinal axis. Hook-and-loop fastening material 26 may be secured to mounting panel 20 stitching, adhesive, or any other suitable bonding method. Main windscreen sheet 30 also includes upper and lower peripheral edge portions having hook-and-loop fastening material, referenced as 32A and 32B respectively, secured thereto. While the preferred embodiment contemplates the use of hook-and-loop fastening material the present invention may be adapted with snap connectors, zipper-type connectors, or any other connector suitable for quick and easy removable attachment of main windscreen sheet 30 to panels 20.

Windscreen system 10 is installed by first affixing mounting panels 20A and 20B to the fence in horizontally disposed, vertically spaced relation, in proximity to the top and bottom portions of the fence. The panels are preferably affixed to the fence using tie wraps 25 inserted through grommets 24. Mounting panel 20A is mounted to the upper portion of the fence with the grommet side disposed above the hook and loop material. Mounting panel 20B is mounted to the lower portion of the fence with the grommet side disposed below the hook and loop material. Main windscreen sheet 30 is removably attached to mounting panels 20A and 20B by engagement of hook-and-loop fastening material 32A with material 26A, and material 32B with material 26B.

In this preferred embodiment, the use of hook-and-loop fastening material is maximized such that strips thereof run substantially the entire length of mounting panels 20A and 20B, and main wind screen sheet 30. As should be apparent, windscreen sheet 30 may be quickly and easily installed by simply pressing the edges of sheet 30 to mounting panels 20 whereby the hook-and-loop fastening material maintains sheet 30 removably affixed to panels 20. Removal of windscreen sheet 30 is thus easily accomplished by simply grasping the sheet and applying force to separate the hook-and-loop bond. The mounting configuration further allows for partial removal, such as by detachment of the top or bottom edge only, whereby the sheet may be rolled up and secured either near the bottom or top of the fence. Accordingly, the present invention further contemplates affixing tie-strings to either main sheet 30 or mounting panels 20 to secure the main sheet in a rolled-up configuration.

In an alternate embodiment, a lesser quantity of hook-and-loop fastening material used thereby resulting in reduced bond strength so as to allow windscreen sheet 30 to automatically separate from one or both mounting panels 20 in the event that a wind gust is experienced thereby avoiding damage to the fence. In this alternate embodiment, the amount of hook-and-loop fastening material is minimized such that the force required to separate the main windscreen from the mounting panels is less than the force that would cause structural fence failure, such that the windscreen would automatically breakaway from the fence in high wind conditions.

In accordance with this embodiment, wind pressure is taken into account in along the bond strength characteristics of the hook-and-loop fastening material. A general formula for calculating drag from wind resistance is: F_{d}−½ (pv²AC_{d}) where C_{d} is the object's drag coefficient, which depends on the shape of the object (typically 1.17 for a flat plate), p is the density of the medium (air=1.293 kg/m³), A is the frontal surface area, and v is the velocity of the wind. Accordingly, the force resulting from a 50 mph (22.35 m/s) wind impacting generally perpendicular on a 6′×20′ (180 ft² or 16.8 m²) flat sheet is:

F_{d}=½(1.293 kg/m3)(22.35 m/s)²(16.8 m²)(1.17)

F_{d}=6,348 Newtons=1,426 lbs.

The above-referenced calculation provide an example of one basic method for calculating forces that may be experienced by windscreen systems to provide a means for determining the quantity of hook-and-loop fastening material, or other connection structure, that may be used to achieve a breakaway function thereby preventing damage to the fence structure. As should be apparent, the calculations may be adjusted to arrive at design parameters for virtually any fence size, fence loading value, and/or desired maximum wind speed.

In yet another contemplated embodiment, a single mounting panel 20 is provided with a windscreen sheet 20 having hook-and-loop fastening material along one peripheral edge with grommets along an opposing edge. In accordance with this embodiment, the mounting panel may be affixed to the top portion (or alternatively the bottom portion) of the fence, with the windscreen sheet more permanently affixed to the bottom portion of the fence via the grommet and tie-wrap method. This configuration allows the top portion of the windscreen to be removed such that the windscreen may be rolled-up to a compact storage configuration along the bottom of the fence.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A windscreen system for attachment to a fence, said system comprising:
first and second mounting panels, each mounting panel including a plurality of grommets disposed in spaced relation along the length thereof and at least one strip of hook-and-loop fastening material affixed to said panel along at least a portion of the length thereof;
a windscreen sheet having a top peripheral edge and a bottom peripheral edge, said top and bottom peripheral edges including at least one strip of hook-and-loop fastening material;
said first mounting panel affixed to an upper portion of the fence;
said second mounting panel affixed to a lower portion of the fence;
said windscreen sheet top peripheral edge removably attached to said first mounting panel via hook-and-loop fastening; and
said windscreen sheet bottom peripheral edge removably attached to said second mounting panel via hook-and-loop fastening.

2. A windscreen system according to claim 1, further including tie stings for use in securing said windscreen in a rolled configuration for storage.

3. A windscreen system according to claim 1, wherein said the hook-and-loop fastening material is selected to maintain the windscreen attached to said mounting panels when wind speeds are below a predetermined threshold value, and to allow for release of at least a portion of said windscreen from at least one of said mounting panels when said wind speeds are above said threshold value.
